(19) United States
(12) Patent Application Publication
(10) Pub. No.: US 2006/0277097 A1
(43) Pub. Date: Dec. 7, 2006

(54) Digital marketing and fulfillment system

(75) Inventors: Thomas J. Shafron, Miami Beach, FL (US); David C. Shafron, Miami Beach, FL (US)

Correspondence Address: MICHAEL J. BUCHENHORNER, 8540 S.W. 83 STREET, MIAMI, FL, 33143, US

(73) Assignee: Event Doctors, LLC

(21) Appl. No.: 11/145,651

(22) Filed: Jun. 6, 2005

(51) Int. Cl. G06Q 30/00; G06Q 10/00

(52) U.S. Cl. 705/14; 705/5

(57) ABSTRACT

A method that allows Event Holders to set their own advertising rates to compete on an advertising network by providing advertisements based on the Projected Rate of Return in a risk free manner to the Event Holder. The method includes steps of receiving from an Event Holder a request for selling tickets to an event; transmitting an advertisement at the request of an Advertising Network Member or transmitting an advertisement to software or hardware (e.g. chipsets) on a Consumer's machine that displays advertisements; receiving a ticket order that resulted from an advertisement; and Transmitting a Bill to the Event Holder for the Advertising Fee earned in selling the ticket. The method can be implemented with an online marketing system that includes a marketing server and one or more Advertising Network Members connected to the server for distributing advertising for the tickets

### FIELD OF THE INVENTION

The invention disclosed broadly relates to the field of information processing and more particularly relates to the field of digital advertisement and fulfillment of orders for goods and services.

### BACKGROUND OF THE INVENTION

Many persons producing events (herein defined as “Event Holders”) have trouble selling all the tickets of the facility where the event is held because they cannot afford to spend enough on marketing or because they do not want to discount their ticket prices because that would condition the public to wait for the discount. Therefore there is a need for a method and system for advertising and selling tickets to an event that overcome these shortcomings.

### SUMMARY OF THE INVENTION

Briefly, according to an embodiment of the invention a method allows event holders to set their own advertising rates to compete on an advertising network by providing advertisements based on a projected rate of return in a risk free manner to the event holder. The method can optionally be implemented as one or more server machines connected to a network of marketing sites. The method and system eliminate the risk of paying for ineffective advertising by an Event Holder because the Event Holder only pays for advertisements that directly or indirectly lead to sales.

### BRIEF DESCRIPTION OF THE DRAWINGS

FIG. 1 is a high level block diagram showing an information processing system according to another embodiment of the invention.

FIG. 2 is a flowchart of a method according to an embodiment of the invention.

FIG. 3 is a high level block diagram illustrating an online ticket purchase by a user.

### DETAILED DESCRIPTION

The following terms shall be defined as follows only for purposes of the description of the illustrative embodiment and examples. When these and similar terms are used in the claims their meaning may vary in scope in a manner commensurate with the scope of the claimed invention.

Definitions:

Advertising Network Member—Any Web site that chooses to provide advertising space for events using an Online Marketing System (OMS) according to an embodiment of the invention.

Advertisement Network—A network of Advertising Network Members who participate in the OMS.

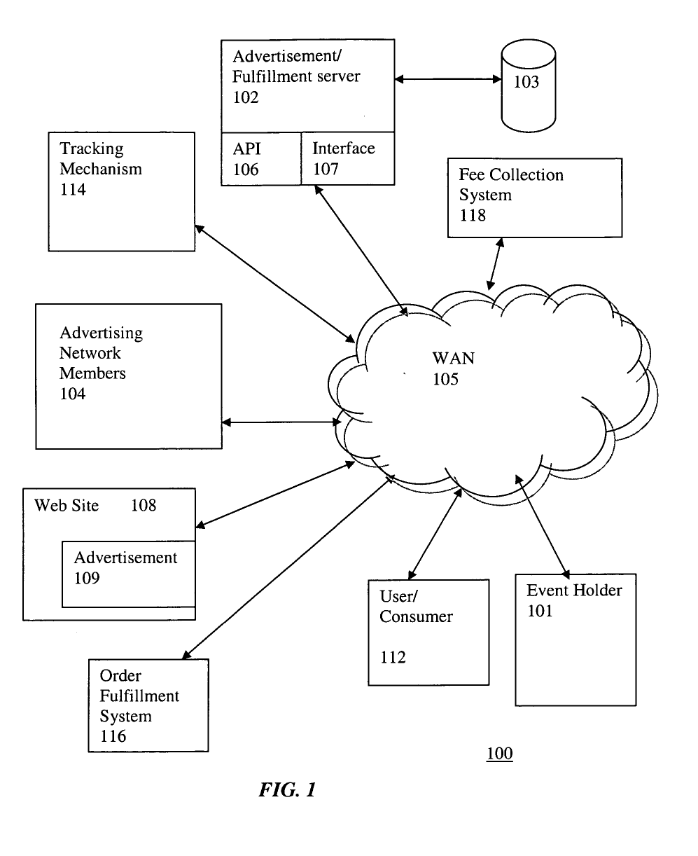

Advertising Fee—an amount set by the Event Holder whether as a percentage or an absolute dollar amount per ticket or group of tickets sold or both to be paid to the Online Marketing System for all ticket orders from the Online Marketing System. The Advertising Fee amounts can also be limited by an absolute total dollar amount, by passage of time, or by limiting it to specific tickets to market, at the Event Holder's choosing. There are two types of Advertising Fees, Direct and Indirect. Direct Advertising Fees are Advertising Fees paid for advertisements that lead directly to a sale. To earn a Direct Advertising Fee, a Consumer 112 (see FIG. 1) must select (e.g. click on) an advertisement and order tickets from the fulfillment system that the advertisement sends the Consumer 112. Indirect Advertising Fees are Advertising Fees paid to the Online Marketing System for advertisements displayed on the Online Marketing System that were shown to a Consumer 112 who eventually placed an order for that same event by means other than that would qualify as a Direct Advertising Fee. The Indirect Advertising Fee can be set using a percentage rate or on a cost per ticket basis with limitations as discussed above. Whether by percentage or dollar amount subject to any limitations they decide to place on the total percentage or dollar amount they place on Indirect or total Advertising Fee payout. In the cases of both Direct and Indirect Advertising Fees, the Event Holder only pays for an advertisement that can be linked to a sale. When Event Holders set their Advertising Fee rates, they may choose to enter rates for either Direct Advertising Fees or Indirect Advertising Fees or both. The Online Marketing System will distribute the Advertising Fees appropriately after an order has taken place. Event Holders may choose to offer an Indirect Advertising Fee to alter the Projected Rate of Return for a given advertisement in order to affect the frequency that it is displayed.

Application Programming Interface (API)—a group of functions that allow event Advertising Network Members to send Limiting Criteria, Behavioral, demographic and geographic data to the Online Marketing System which will enable the Online Marketing System to display advertisements on the Advertising Network Members Web sites through the use of HTML code on the part of the Advertising Network Member.

Behavioral data—Any data or information concerning any and all aspects of consumer behavior of one or more individuals, online or offline, including, but not limited to: order history, consumer preferences, consumer response to advertisements both to specific advertisements and advertisements in general, etc.

Billing, Transmit a Bill—Both Billing and Transmit a Bill includes the concept of deducting the amount of the Advertising Fee directly from an order and distributing the remaining proceeds to the appropriate parties, and as done in the traditional sense of the concept.

Browser—a software program which allows people to view sites on the Internet.

Consumer—a person who visits an Advertising Network Member's Web site and views an advertisement on OMS and may potentially make a purchase.

Content (also called Site Content or Content Information)—Any media, information, topics discussed and languages that an Advertising Network Member displays to its users in general as well as any specific media, information, topics discussed and languages shown to a Consumer at the time an advertisement is requested.

Cookie—Popular means by which Web sites store and track information about Consumers 112 to their Web sites.

Event Data—Any data that is entered in the online marketing system database that includes but is not limited to: 1) Event type; 2) Event location; 3) Ticket pricing; 4) Discounts or promotions (% or $); 5) Advertising Fee; 6) Event date; 7) Event pitch; 8) Event title; 9) Number of tickets available; and 10) Seating chart.

Event Holders—Any entity that creates and/or hosts and/or promotes a live event.

HTML code—Hypertext Markup Language, the standard mark-up language used for creating Web sites on the Internet.

Internet Protocol Address (IP Address)—a number assigned to a device using the Internet to be used as a unique identifier.

Limiting Criteria—the criteria Advertising Network Members use to limit the scope of advertisements that appear on their Web site. Limiting Criteria can include but are not limited to: choosing a specific advertisement or a specific event or both, choosing one or more events by type, location, subject matter, content, performer, duration, reviews, price, etc.

Online Marketing System (also called Online Marketplace System or OMS)—the system used to create an online marketplace which combines marketing and sales wherein advertisement is provided on a reduced risk or risk-free basis.

Operator—the party that implements the Online Marketing System discussed herein and manages all the required systems and business relationships to do so.

Projected Rate of Return—The standard by which the Online Marketing System determines the most profitable advertisements to display on an Advertising Network Member's Web site at any given time to a Consumer. The Projected Rate of Return is based upon the projected rate at which the advertisement will generate Direct and Indirect Advertising Fees, which is in turn, based upon general and specific Behavioral, geographic and demographic data about Consumers, the specific advertisements as well as the type of advertisements already seen by the Consumer as well as when these advertisements were seen, Content Information about the Advertising Network Member's Web site, Event Data, the Advertising Fee structure, the ticket pricing and the success rate of the advertisement leading to a sale leading to Direct and/or Indirect Advertising Fees being earned by Online Marketing System. The lower the Projected Rate of Return, the less an advertisement would be shown, thus forcing Event Holders to compete against each other to offer a higher Projected Rate of Return for their advertisements.

Rate of Return—The total Direct and Indirect Advertising Fees collected for a given advertising run divided by the number of times the advertisement was displayed.

Universal Resource Locator (URL)—the means by which Consumers use the World Wide Web to navigate Web sites.

The Online Marketplace:

Referring to FIG. 1, there is shown a high level block diagram of an Online Marketplace System 100, according to an embodiment of the invention. The system 100 is an example of an OMS and comprises an advertising/fulfillment server 102 connected to one or more databases 103 for storing event information, Consumer information, transaction information and Content Information. The server 102 is also connected to a wide-area network 105 such as the Internet. The system 100 is managed by an Operator that has relationships with one or more Advertising Network Members 104. For example, an Advertising Network Member 104 can be under contract with the Operator to display advertisements for events. The Advertising Network Member 104 receives HTML code from the Operator that retrieves the advertisements from a server controlled by server 102 (or directly from the server 102). The Advertising Network Member 104 uses an API 106 that facilitates the placement of advertising in the most advantageous manner. The server 102 determines which advertisements to transmit based on data provided by the Advertising Network Member 104 and data stored in database 103. The Advertising Network Members 104 control Web sites 108 wherein the advertisement can be displayed to Consumers 112. The system 100 can be implemented in many different configurations where functionality is distributed among different nodes in the network or concentrated in one or more nodes.

An Event Holder 101 is also connected to the network 105. The Event Holder 101 has a plurality (e.g., hundreds or thousands) of tickets to an event that it has to sell to users of the systems such as Consumers 112. In order to sell those tickets, the Event Holder 101 may use an existing relationship (or establish a new relationship) with the Operator of the system 100 or the server 102. Once a relationship exists, the Event Holder 101 can receive a user ID and a password to communicate with the server 102. In this embodiment, the system 100 is used to sell tickets but other embodiments may use the system 100 to sell any other goods or services in a manner similar to that discussed herein.

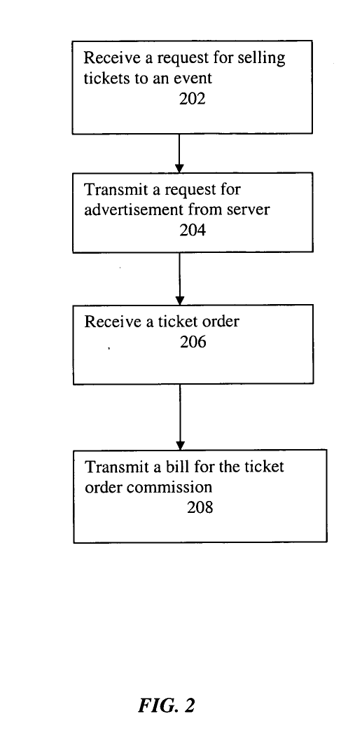

Referring to FIG. 2, there is shown a flow chart illustrating an information processing method according to an embodiment of the invention. The method begins at step 202 wherein a request for selling tickets to an event is received from a client such as the Event Holder 101. In step 204, another client such as the Advertising Network Member 104 transmits a request for a placement of an advertisement from the server 102. The Advertising Network Members 104 place code on their Web sites 108 to inform the Consumer's browser 112 to request the advertisements from the Online Marketing System 100. In step 206 the server 102 receives a ticket order that resulted from an advertisement 109 posted on the Web site 108 of Advertising Network Member 104. A Consumer typically places a ticket order by clicking on an area of the screen displaying the advertisement. In step 208, the server 102 Transmits a Bill to the Event Holder 101 for the Advertising Fee earned by the Online Marketing System 100 in selling the ticket(s).

This marketplace system 100 creates an incentive for Event Holders 101 to compete with each other to place risk-free advertisements on an advertising network of Advertising Network Members by providing the Online Marketing System 100 with a higher Projected Rate of Return. The system 100 includes an Advertising Network that is a combined marketing and fulfillment network. The vertical integration of the sales and marketing network allows the system 100 to offer Event Holders 101 risk-free advertisements because Event Holders 101 only pay Advertising Fees on the specific advertisements that directly or indirectly led to specific orders from Consumers 112.

The marketplace system 100 described above can be implemented by maintaining a database of Event Data 103 that can be updated (e.g., in real-time), an interface 107 for Event Holders to set and change Advertising Fees (e.g., in real-time), and a method for Advertising Network Members, through an API 106, to request advertisements from the Online Marketing System API. According to another embodiment, the server 102 uses a method to determine the proper advertisement to display. According to yet another embodiment, the server 102 uses a mechanism to Transmit a Bill to the Event Holders and distribute the Advertising Fees. These embodiments are discussed in detail herein.

A Network of Advertising Network Members.

The system 100 uses an advertisement creation system that can create advertisements (e.g., in real-time) or use an advertisement that was created earlier. The system 100 also uses an advertisement Projected Rate of Return algorithm to determine which advertisements to display to a given Consumer 112 (e.g. in real-time).

An advertisement rule system allows Advertising Network Members 104 to request advertisements, based on Limiting Criteria (e.g in real-time).

The system 100 uses an advertisement display system which is based on the Projected Rate of Return for a specific Consumer 112 of an Advertising Network Member Web Site and the Limiting Criteria chosen by the Advertising Network Member.

The system 100 also comprises a tracking mechanism 114 to track which Advertising Network Member 104 and/or which specific advertisement on the OMS directly led to a Consumer 112 purchasing tickets, or which Advertising Network Members 104 and/or which advertisements on the OMS led to the occurrence of an Indirect Advertising Fee.

An order fulfillment 116 system logs which advertisement led to a purchase. A fee collection system 118 assures that payment is received from the purchaser. An Advertising Fee distribution system distributes the correct portion of the Advertising Fees to the appropriate parties.

When the components discussed above are combined in the system 100, the system enables: (1) Event Holders to update their Event Data (e.g., in real-time) and choose the specific amount of money to spend in order to obtain a specific level of sales (e.g., in real-time), and (2) an Online Marketing System to determine and display appropriate advertisements (e.g., in real-time) to individual Consumers 112 on the Advertising Network Members' Web sites; (3) an Online Marketing System to collect and distribute fees from the Event Holders and to Advertising Network Members after an order for tickets takes place through a Billing system. This will allow Event Holders to continually improve the attractiveness of their advertisements (particularly by adjusting the Advertising Fee amount or rate) to the Advertisement Network.

Marketing has been traditionally considered a selling, general, and administrative expense because Event Holders are unable to directly attribute a marketing dollar spent to the sale of one or more tickets. The OMS changes the nature of a marketing expense to a cost of goods sold as Event Holders are now able to directly correlate every marketing dollar spent on the OMS system to ticket sales.

The intense competition between Event Holders to have their advertisements shown on the limited number of advertisement space provided by an OMS Network of Marketing Web sites combined with the risk-free nature of the advertising spending to the Event Holders 101 (Advertising Fees are linked to sales), increases profits to the Advertising Network as well as the competitiveness of this advertising system to more traditional advertising, and thus more Web 108 sites throughout the Internet become part of the Advertising Network.

Online Marketing Process:

Event Holders 101 can link their on-line advertising budget directly to ticket sales by using the Online Marketing System 100. Event Holders 101 enter their Event Data into a database 103. In addition to the detailed event information, the Event Holders will also enter the Advertising Fee structure for any tickets they choose to advertise on the OMS. The Advertising Fee structure can be specific to one or more individual tickets or any structural superset (group of tickets, individual or group of rows, individual or group of sections, individual or group of levels, and the like). The Advertising Fee can also be limited to a total dollar amount or total percentage amount of sales for the entire event. Event Holders 101 can further customize their specific OMS advertising campaign by setting date and time parameters for the advertisements to display.

The system 100 combines all of the event, Content and consumer information in the database 103 with the Advertising Fee structures for each individual event with the Limiting Criteria, Content and consumer information provided by the Advertising Network Members 104. The Limiting Criteria and consumer information are passed to the Online Marketing System 100 through arguments in the URL that requests the advertisement, or stored on Online Marketing System's 100 database 103 by the Advertising Network Member 104 when they add their site to the OMS Network, to be shown to a specific Consumer 112 on an Advertising Network Member's Web site 108. The Online Marketing System 100 then serves an advertisement 109 to the Consumer 112 on the Advertising Network Member's Web site 108 based upon the Projected Rate of Return to the Online Marketing System 100 for that specific Consumer 112 which falls into the parameters of the Advertising Network Member's Limiting Criteria.

Each advertisement is associated with the Consumer 112 through either storing data on the browser (e.g., a cookie) or storing the fact that the advertisement was shown to that specific Consumer 112 in the Event Doctor's database. If the Online Marketing System's database 103 is used to store the fact than an advertisement was displayed to a specific Consumer 112, then the Online Marketing System places a unique key in the browser (e.g., a cookie) to identify the Consumer 112 to Online Marketing System's database 103. In addition, when a Consumer 112 clicks an advertisement, Online Marketing System associates the fact that they clicked on the advertisement in the same manner described above for associating a Consumer 112 with viewing the advertisement that the Online Marketing System's order handling system will use during the ordering process to identify the advertisement and the Advertising Network Member who enabled the sale of the tickets. If the Consumer 112 then proceeds to make a purchase through the Online Marketing System's ordering system servers 102, the Online Marketing System 100 splits the Advertising Fee specified by the Event Holder for that ticket with the Advertising Network Member.

The Event Holders 101 using OMS to market their events only have to pay for advertising that leads to an order of one or more tickets. Therefore, they will no longer need to set a budget for advertising. Furthermore, Event Holders 101 must compete on the OMS Network to provide advertisements and Advertising Fee structures that generate a higher Projected Rate of Return on the Advertising Network or their advertisement will not display frequently.

OMS from the Event Holder's Point of View:

The Event Holder 101 enters detailed Event Data into the database 103. The OMS 100 uses the Event Data to determine whether a given event falls within the Limiting Criteria provided by each individual Advertising Network Member and it also helps in determining the Projected Rate of Return for given advertisements at a specific time. For example, if an event is located in Alaska, it would not provide a high Projected Rate of Return to display an advertisement for this event to a Consumer 112 in New York.

One of the critical pieces of the Event Data entered by the Event Holder is the Advertising Fee rate on tickets they have available for sale. Once the Event Holder 101 chooses one or more tickets to advertise on the OMS, an advertisement is created (if it was not created already by hand or automatically by the OMS system), it is then placed on a list of advertisements to be displayed. When a Consumer 112 visits an Advertising Network Member's Web site 108, the Event Holder's advertisement 109 will be displayed based on the Projected Rate of Return for that advertisement 109 to that Consumer 112 at that time. A preferable scenario for the Online Marketing System 100 is, once a ticket is sold through OMS, the Online Marketing System 100 collects the gross ticket amount, deducts, the appropriate Advertising Fee entered by the Event Holder and distributes the remaining proceeds to the Event Holder. Alternatively, the Online Marketing System 100 can bill the Event Holder depending on the nature of the sale and the business arrangement between Online Marketing System and the Event Holder. In the case where the Online Marketing System 100 collects the receipts from the ticket sales, the Event Holder 101 is never prepaying for marketing as Advertising Fees are deducted only after an order is placed. Alternatively, if Online Marketing System 100 is billing the Event Holder 101 for the Advertising Fees, the Online Marketing System 100 could request a deposit depending on the business arrangement between the Event Holder 101 and Online Marketing System 100.

There are two types of Advertising Fees that the Event Holder may enter into the system, Direct Advertising Fees and Indirect Advertising Fees. The Event Holder may enter either Direct or Indirect Advertising Fees or both for a given advertisement.

If a Direct Advertising Fee is earned for an event, no Indirect Advertising Fees are paid out. An Indirect Advertising fee would be paid out, for example, if the Consumer 112 saw three advertisements on three Different Advertising Network Members' Web sites that said go to XYZ's concert but did not click on any of the advertisements, then independently went to XYZ's Web site to purchase tickets, Online Marketing System 100 would collect the Indirect Advertising Fee upon the placement of the order, if the Event Holder chose to offer Indirect Advertising Fees for this advertisement.

Whether the Advertising Fee paid is Direct or Indirect, the liability for payment of the Advertising Fee occurs only after an order has been placed and payment funds have been collected, allowing the Event Holder to advertise in a risk-free manner.

OMS from the Advertising Network Member's Point of View:

Advertising Network Members 104 place HTML code on their sites 108 which causes a Consumer's Web browser 112 to request an advertisement for an event from the server(s) 102 based upon the Limiting Criteria of the Advertising Network Member 104, in addition to specific and general data about the Advertising Network Member's site and the Consumer 112 in order to help the OMS determine the optimal advertisement to show to the Consumer 112. The type of data provided by the Advertising Network Member includes but is not limited to one or more of the following: (1) specific event types or one or more specific individual events; (2) events in one or more specific geographical locations; (3) general and specific Behavioral, demographic and geographic information of the browser currently visiting the Advertising Network Member's Web site (generally from a cookie); (4) general and specific Behavioral, demographic, and geographic data on the site's users; (5) any information gained from EP addresses (geographic and otherwise) of Consumers 112 who visit the Web site; (6) the Content of the Web site; (7) the number of advertisements requested; and (8) the dimensions and placement of the advertisement(s).

When a Consumer 112 visits the Advertising Network Member's Web site 108, the Consumers Browser 112 requests the URL for the advertisement. The arguments, IP Address, cookies and all other data are communicated to the Online Marketing System servers 102 along with the above URL request. This allows the OMS to combine information provided above with the information the Online Marketing Network has in its database 103 to allow it to send any number of advertisements requested based upon the Projected Rate of Return. If the Consumer 112 to the Advertising Network Member's site clicks on a Web site Advertisement 109, the OMS enters an identifier, generally a cookie into the Consumer's browser 112 with a unique identifier of the Advertising Network Member and/or the specific advertisement, which allows the Online Marketing System 100 to determine with whom to split the Advertising Fee for the sale of the ticket(s). Once the purchase is made, the Online Marketing System 100 distributes its portion of the Advertising Fees to the Advertising Network Member 104 according to the business arrangement made with the Advertising Network Member 104.

OMS from Online Marketing System's Point of View:

Once Event Holders 101 choose to use OMS, the OMS combines the event information, Advertising Fee structures, and success rates of the advertisements stored in database 103 with the information provided by the Advertising Network Member 104 (Limiting Criteria, Content Information, general Behavioral, demographic and geographic information, and Behavioral, demographic and geographic information of the specific Consumer 112 to the site at the time that specific Consumer 112 is using the site) with data that the Online Marketing System 100 provides about the Consumer 112, to determine the advertisement to display to the specific user of the Advertising Network Member 104. During this process, the Online Marketing System 100 will also record the advertisement, the Consumer 112 and the Advertising Network Member 104 in its system, or the Online Marketing System 100 can send a cookie or other identifier to the Consumer's browser 112 which will store the advertisement(s) and the Advertising Network Members 104 who showed them, so that in the case that the Event Holder is offering Indirect Advertising Fees, the Indirect Advertising Fee will be appropriately distributed if no Direct Advertising Fee is paid on the event. Once the Consumer 112 clicks on an advertisement, the Online Marketing System 100 then uses an identifier, generally a cookie or stores in the Online Marketing System database 103 that a given advertisement was clicked, which contains the unique identifier of the Advertising Network Member 104, and/or the specific advertisement displayed, so the Advertising Network Member 104 can be credited with any sale that may happen through the Online Marketing System 100 transaction system. If an advertisement leads directly to an order, the Online Marketing System 100 collects the entire payment for the order and deducts the Advertising Fee specified for that ticket by the Event Holder 101. If one or more advertisements leads to an Indirect Advertising Fee, and the Online Marketing System 100 collects the entire order amount, the Online Marketing System 100 deducts the entire Indirect Advertising Fee amount and then splits the Indirect Advertising Fee between the Online Marketing System 100 and the Advertising Network Members 104 who showed the Advertisements that qualified for the Indirect Advertising Fee and the remaining amount, less any service or processing fees that do not go to the Event Holder 101, are distributed to the Event Holder 101.

In the case where the Online Marketing System 100 collects the receipts from the ticket sales, the Event Holder is never prepaying for advertisement because Advertising Fees are deducted only after an order is placed and the money is collected. Alternatively, if the Online Marketing System 100 is billing the Event Holder 101 for the Advertising Fees, the Online Marketing System 100 can request a deposit depending on the business arrangement between the Event Holder 101 and the Online Marketing System 100.

In either case, appropriate distributions are made according to the business arrangements of the various parties involved. Another option to track order placement is where the Online Marketing System 100 is simply notified that a purchase has taken place as a result of an advertisement sent from the Online Marketing System servers 102. Online Marketing System 100 can then receive its Advertising Fee through billing the Event Holder 101 or through a direct deposit. The Online Marketing server 102 would be notified of the sale through a third-party transaction system and the Event Holder has an incentive to notify the Online Marketing System 100 of the sale or the Projected Rate of Return on the advertisement would decrease and the advertisement would be shown less on the network.

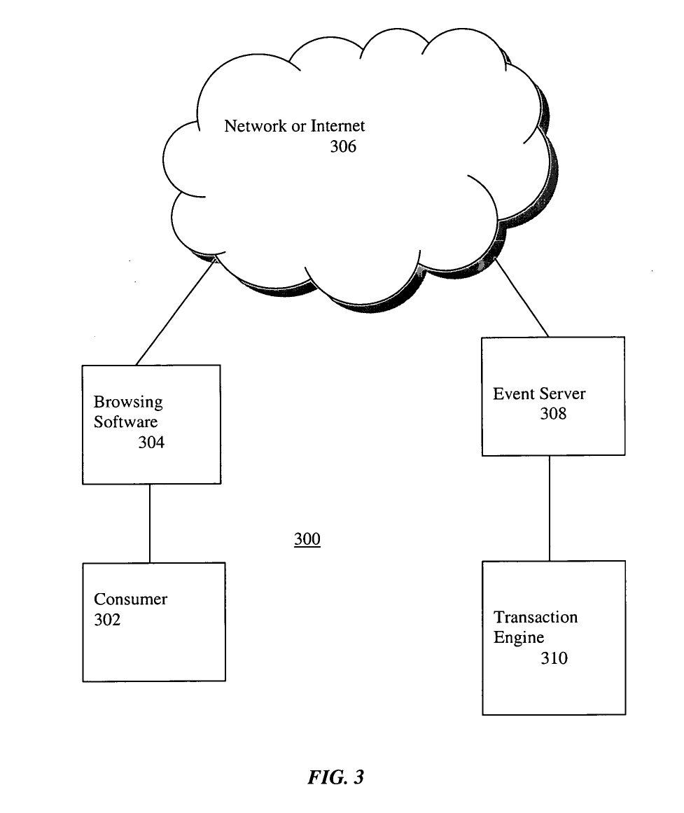

Referring to FIG. 3 we show a simple block diagram illustrating a system for ordering a ticket online according to an embodiment. A Consumer 302 uses his or her browser 304 to communicate with an event server 308 via a network such as the Internet 306. Thus, the Consumer 302 requests a Web page from the server 308. The server 308 responds by transmitting a Web page offering tickets to the event. The Consumer selects (e.g., clicks on) an area of the Web page designated for ordering one or more tickets for the event. The Consumer 302 then may be led to another site (e.g., by a hyperlink) where he or she can order the desired ticket or tickets for the event advertised. The order can be completed with the help of a cookie that identifies the Consumer to the ordering system 300. The Consumer's order can be handled by a transaction engine 310 which may reside in one or more event servers or as one or more standalone machines. The ordering system logs the advertisement and/or Advertising Network Member that generated the sale in order to distribute a share of the Advertising Fee to the marketing site.

Therefore, while there has been described what is presently considered to be the preferred embodiment, it will understood by those skilled in the art that other modifications can be made within the spirit of the invention.

We claim:

1. A marketing method comprising steps of:
receiving from a client a request for selling tickets to an event;
adding an advertisement to a list of advertisements available for display to consumers, wherein the advertisement to be displayed is determined according to a projected rate of return standard based upon a fee that is to be paid for a sale combined with the probability that the advertisement leads to a sale;
displaying the advertisements to consumers; and
receiving an indication that an order resulted from an advertisement displayed to consumers.

2. The method of claim 1, further comprising receiving the fee earned by the sale.

3. The method of claim 1, further comprising receiving a message from a client setting a fee to be paid for advertisements that lead to a sale.

4. The method of claim 1, further comprising steps of transmitting the ticket to the consumer that ordered the ticket and confirming payment for the ticket order.

5. The method of claim 1, further comprising placing an advertisement for one or more tickets across a network of Web sites.

6. The method of claim 1, wherein the step of displaying an advertisement is also based upon behavioral, geographic and demographic data known about the consumer.

7. The method of claim 1, wherein the step of displaying an advertisement is based on one or more of: the number of times an advertisement was displayed to a consumer; the timing of when those advertisements were displayed; or the consumer's response to those advertisements.

8. The method of claim 5, further comprising receiving a set of limiting criteria from a network Web site wherein the limiting criteria comprise one or more of: choosing a specific advertisement or a specific event or both; or choosing one or more events by type, location, subject matter, content, performer, duration, reviews, and price.

9. The method of claim 1, further comprising receiving from the client and using data to select an advertisement to be displayed to the user, the data including one or more of: an event type; an event location; a ticket pricing; discounts or promotions; an advertising fee; an event date; an event pitch; an event title; a number of tickets available; and a seating chart.

10. The method of claim 4, wherein confirming payment comprises receiving a credit or debit account number.

11. The method of claim 1, further comprising receiving a fee for one or more advertisements shown to a consumer where the consumer purchased one or more tickets to the advertised event but did not select the one or more advertisements.

12. The method of claim 1, further comprising receiving a fee for advertisements shown to a consumer where the consumer purchased tickets to an advertised event directly as a result of the advertisement during a single session.

13. The method of claim 5, further comprising receiving from a network Web site behavioral, demographic, and geographic data.

14. The method of claim 5, further comprising combining data provided by a network Web site with data stored in a database to select an advertisement to be displayed to a consumer.

15. The method of claim 5, further comprising selecting an advertisement to be displayed to a consumer based on the content of a network Web site where the advertisement is displayed.

16. The method of claim 1, further comprising selecting an advertisement to be displayed to a consumer based on the history of consumer preferences and purchases.

17. An online marketing system comprising:
a marketing server;
a Web site that markets events comprising an interface with the marketing server for receiving advertisment requests; and
a Web site that handles ticket orders for receiving requests for sale of a number of tickets to an event;
wherein the marketing server is configured for adding an advertisement to a list of advertisements available for display to consumers, wherein the advertisement to be displayed is determined according to a projected rate of return standard based upon a fee that is to be paid for a sale combined with the probability the advertisement leads to a sale.

18. The system of claim 17, further comprising a tracking mechanism to track which network Web site provided the space for and which advertisement was displayed to a consumer.

19. The system of claim 17, further comprising a tracking mechanism to track which network Web site provided the space for and which advertisement was selected by a consumer.

20. The system of claim 18, further comprising an order fulfillment system that logs one or more of the following; which one or more advertisements that were seen by a consumer that made a purchase; and one or more Web sites that displayed advertisements which were seen by a consumer that made a purchase.

21. The system of claim 19, further comprising an order fulfillment system for logging one or more of the following; at least one selected advertisement that led to a purchase; and at least one Web site that displayed the advertisement that led to a purchase.

22. The system of claim 17, further comprising an advertising fee distribution system.

23. An online marketing server comprising:
an event holder interface for receiving from an event holder a request for selling tickets to an event and for collecting a fee for each ticket that is purchased as a result of an advertisement; and
an advertising network Web site interface for transmitting advertising requests to an advertising network Web site and for receiving orders for advertised tickets from the advertising network Web site, wherein the orders were received responsive to the requested advertisement
wherein the marketing server is configured for adding an advertisement to a list of advertisements available for display to consumers, wherein the advertisement to be displayed is determined according to a projected rate of return standard based upon a fee that is to be paid for a sale combined with the probability the advertisement leads to a sale.

24. The server of claim 23, further comprising a database of event data, wherein the event data comprises one or more of the following: event type; an event location; ticket pricing; discounts or promotions; an advertising fee; an event date; an event pitch; an event title; a number of tickets available; and a seating chart.
